(19) United States
(12) Patent Application Publication
(10) Pub. No.: US 2005/0031475 A1
(43) Pub. Date: Feb. 10, 2005

(54) Bellows pump

(76) Inventor: Fumio Taniguchi, Tokyo (JP)

Correspondence Address: LACKENBACH SIEGEL, LLP, LACKENBACH SIEGEL BUILDING, 1 CHASE ROAD, SCARSDALE, NY, 10583, US

(21) Appl. No.: 10/858,533

(22) Filed: Jun. 1, 2004

(30) Foreign Application Priority Data
Jun. 9, 2003 (JP) 2003-163422

(51) Int. Cl. F04B 43/00; F04B 45/02; F16K 31/12; F16K 31/36

(52) U.S. Cl. 417/472; 417/559

(57) ABSTRACT

The object of the present invention is to provide a bellows pump which is able to accurately pump out a fixed amount of fluid, even with the fluid of high temperature with granular bits included.

The bellows pump 3 is comprised of bellows 20 formed in a shape of accordion, nozzles 30u and 30d arranged at the both ends of the bellows 20, and check valves 40u and 40d arranged at the fluid-flow-inlet 23u and fluid-flow-outlet 23d at the both ends of the aforementioned bellows 20 respectively,

wherein each of the aforementioned check valves 40u and 40d is comprised of a valve base 41 with its downstream surface concaved with more than one holes pierced through it, a valve body 44 made of elastic thin body which is fixed to the downstream surface 41b of the aforementioned valve base 41 with a hole 46 formed at its center for allowing the flow of the fluid, and a pressing element 47 which adds pressure to the aforementioned valve body 44 allowing it to be compressed against the downstream surface of the aforementioned valve base 41, and

aforementioned valve body 44 adheres closely to the downstream surface 41b of the aforementioned valve base 41 by the pressing force of the aforementioned pressing element 47.

### BACKGROUND OF THE INVENTION

1. Field of Invention

The present invention relates to a bellows pump for supplying a fixed amount of fluid at the time of supplying fluid, by connecting it to a fluid accommodating bag in which the fluid is accommodated, and also relates to a system for supplying a fixed amount of fluid utilizing this bellows pump.

2. Description of the Related Art

As a system for supplying a fixed amount of fluid, there has been a system employing a bellows pump. The inventor of the present invention has invented a bellows pump disclosed in reference 1, as a pump to be employed in such system for supplying a fixed amount of fluid. This type of bellows pump is contracted and expanded by moving at least one of either upper or lower end, and thus changing the pressure inside the bellows pump to generate a check valve. When the pressures applied from the upstream and the downstream are approximately the same, or when the pressure is applied only from the downstream, the valve body of the check valve is appressed against the downstream surface so as to plug the fluid-flow-through holes to develop a closed state, and not allow the fluid to flow towards upstream in these states, thereby definitely preventing the reverse flow. Only when the pressure is applied to the fluid from the upstream, the valve body is pushed toward the downstream so as to form a clearance between the valve body and the valve base, so that the fluid flows from the fluid-flow-through holes of the valve base toward the downstream via the hole of the valve body for allowing the flow of the fluid. Thereby, the fluid can be pumped to one direction at an appropriate amount and speed optimum for the kind and viscosity, etc, of the fluid.

Patent Reference 1

Patent Gazette 2002-180969

Meanwhile, since the valve body of the bellows pump is made of elastic material such as silicone rubber, the valve body may expand due to the heat under long hours of use, forming a clearance between the valve base and the valve body. This was a problem, as it may no longer serve as a check valve.

In addition to this problem, when the viscous fluid of hot temperature with tiny granular bits, such as hot sauce spreaded on top of the pizza and such, is poured out of the bellows pump, the granular bits would get stuck between the valve base and the valve body. If the granular bits get stuck between the valve base and the valve body, it not only hinders the function as a check valve, but also obstructs in pumping out the fluid in a fixed amount.

### SUMMARY OF THE INVENTION

In view of the aforementioned issues the present invention has been made, and it is an object of the present invention to provide a bellows pump and a system for supplying a fixed amount of fluid in which the reverse flow of the fluid is eliminated and viscous fluid of hot temperature with tiny granular bits can be delivered in an accurately fixed amount.

In order to achieve the aforementioned object, the present invention is a bellows pump comprising a bellows in a shape of accordion, detachably mounted nozzles arranged at both ends of the aforementioned bellows and 2 check valves arranged respectively at fluid-flow-inlet and fluid-flow-outlet at both ends of the aforementioned bellows,

wherein each of the aforementioned check valve comprises a valve base with its downstream surface concaved with more than one holes pierced through it, a valve body made of elastic thin body which is fixed to the downstream surface of the aforementioned valve base with a hole formed at its center for allowing the flow of the fluid, and a pressing element which adds pressure to the aforementioned valve body allowing it to be compressed against the downstream surface of the aforementioned valve base, and it is characterized in that aforementioned valve body is compressed against the downstream surface of the aforementioned valve base by the pressing force of the aforementioned pressing element, while freely compressing one of the valve body against the valve base and pulling apart the other valve body from the valve base by the expanding and contracting movement of the aforementioned bellows.

Furthermore, the present invention is characterized in that each of the aforementioned check valve is composed to be retained by the end part of the aforementioned bellows on its periphery, and the check valve at the upstream disposed so that the concaved surface is facing the bellows, while the check valve at the downstream disposed so that the concaved surface is facing the nozzle at the outlet end.

Furthermore, the present invention is characterized in that aforementioned pressing element is comprised of supporting part, which is retained on the periphery of the fluid-flow-inlet or fluid-flow-outlet formed at the both ends of the aforementioned bellows, and a pressing element which is formed in the inner perimeter of the aforementioned supporting part and allowing aforementioned valve body to be compressed against the downstream surface of the aforementioned valve base.

Furthermore, the present invention is characterized in that aforementioned pressing element is composed so that the supporting part is in a shape of circular ring, while pressing part is formed on the entire circumference of the inner perimeter of the supporting part in a protruding shape.

Furthermore, the present invention is characterized in that the valve bases and valve bodies which comprise the aforementioned check valves, as well as the pressing element that compresses the valve body against the valve base, are retained with the aforementioned bellows and nozzle clamping the periphery of each of the elements.

Furthermore, the present invention is characterized in that the nozzles mounted at both ends of the aforementioned bellows are both provided with cylinders, and by fastening the cylinders onto the ends of the aforementioned bellows, both nozzles are fixed to the aforementioned bellows.

Furthermore, the present invention is characterized in that the aforementioned valve body is made of elastic material such as silicone rubber in a form of thin film in a disc-shape having a round hole at the center thereof, while more than one fluid-flow-through holes on the aforementioned valve base are arranged in parallel with the axis of the valve base, and spaced equally on the concentric circle, which is situated on the aforementioned axis.

Furthermore, the present invention is characterized in emitting a fixed amount of fluid into the bellows through the check valve arranged at the upstream surface with the expanding movement which compresses the valve body of the check valve arranged at the downstream surface against the valve base and pulls apart the valve body of the check valve arranged at the upstream surface from the valve base at the same time, and also emitting a fixed amount of fluid accommodated in the bellows through the check valve arranged at the downstream surface of the check valve with the contracting movement which compresses the valve body of the check valve arranged at the upstream surface against the valve base, and pulls apart the valve body of the check valve arranged at the downstream surface from the valve base at the same time, with the expansion and contraction of the aforementioned bellows.

Furthermore, the present invention is characterized in comprising a fluid accommodating bag for accommodating fluid therein and a bellows pump connected to the aforementioned fluid accommodating bag, which is a system for supplying a fixed amount of fluid by generating this bellows pump, wherein aforementioned bellows pump comprises bellows in a form of accordion, nozzles disposed detachably at both ends of the aforementioned bellows, and 2 check valves arranged at the fluid-flow-inlet and fluid-flow-outlet of both ends of the aforementioned bellows respectively, wherein each of the aforementioned check valves comprises a valve base with its downstream surface in concaved form with more than one fluid-flow-through holes piercing through it, a valve body made of elastic thin plate with a hole at the center to allow fluid to flow which is arranged at the downstream surface of the aforementioned valve base, and a pressing element which adds pressure so that the said valve body adheres closely to the downstream surface of the aforementioned valve base. Meanwhile the aforementioned valve body is compressed onto the downstream surface of the aforementioned valve base by the pressing force exerted by the aforementioned pressing element, and by expanding and contracting one or both ends of the aforementioned bellows, the valve body of the check valve arranged at the downstream surface is compressed against the valve base with the expanding movement, while the valve body of the check valve arranged at the upstream surface is pulled apart from the valve base with the contracting movement. Thusly, a fixed amount of fluid is delivered to the bellows from fluid accommodating bag via the check valve arranged at the upstream surface, and delivers a fixed amount of fluid in the bellows via the check valve arranged at the downstream by compressing the valve body of the check valve arranged at the upstream against the valve base, while pulling apart the valve body of the check valve arranged at the downstream from the valve base at the same time with the contracting movement.

### DESCRIPTION OF THE PREFERRED EMBODIMENT

An embodiment of the present invention will be described with reference to the attached drawings. First of all, the first embodiment is described.

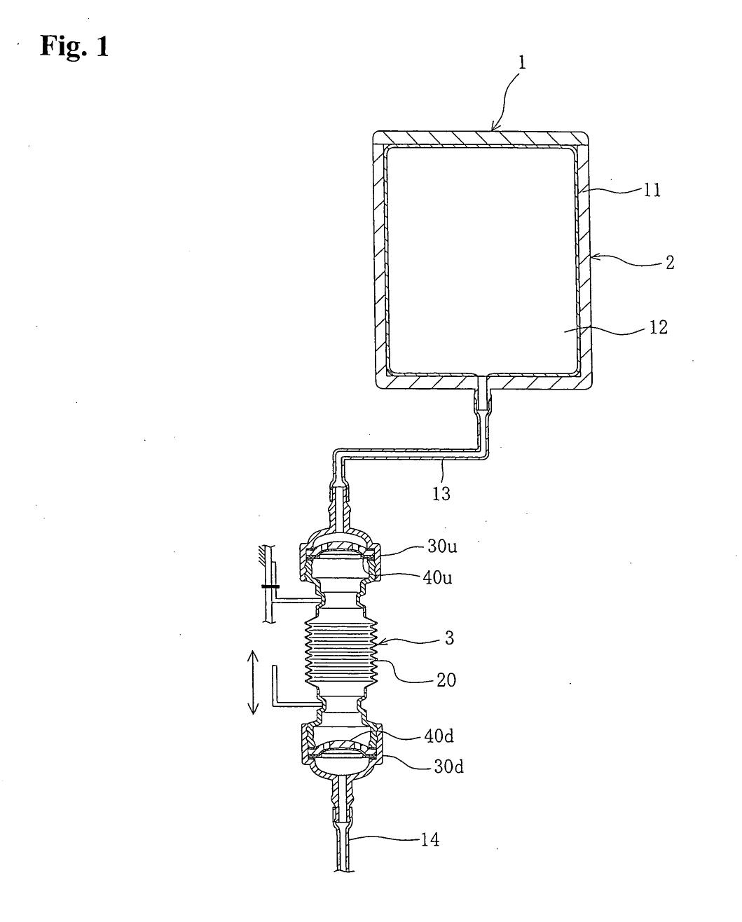

FIG. 1 is a cross sectional view of a system for supplying a fixed amount of fluid according to the first embodiment of the present invention.

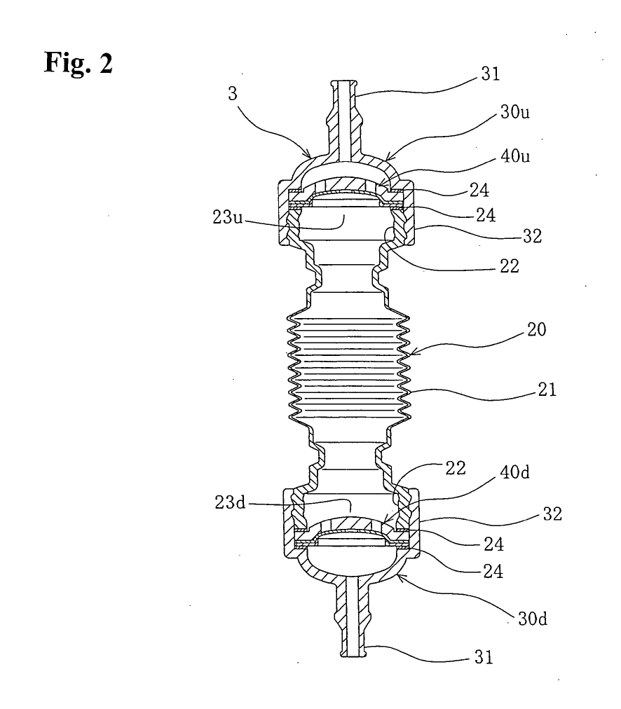

FIG. 2 is a cross sectional view of the bellows pump according to the first embodiment of the present invention.

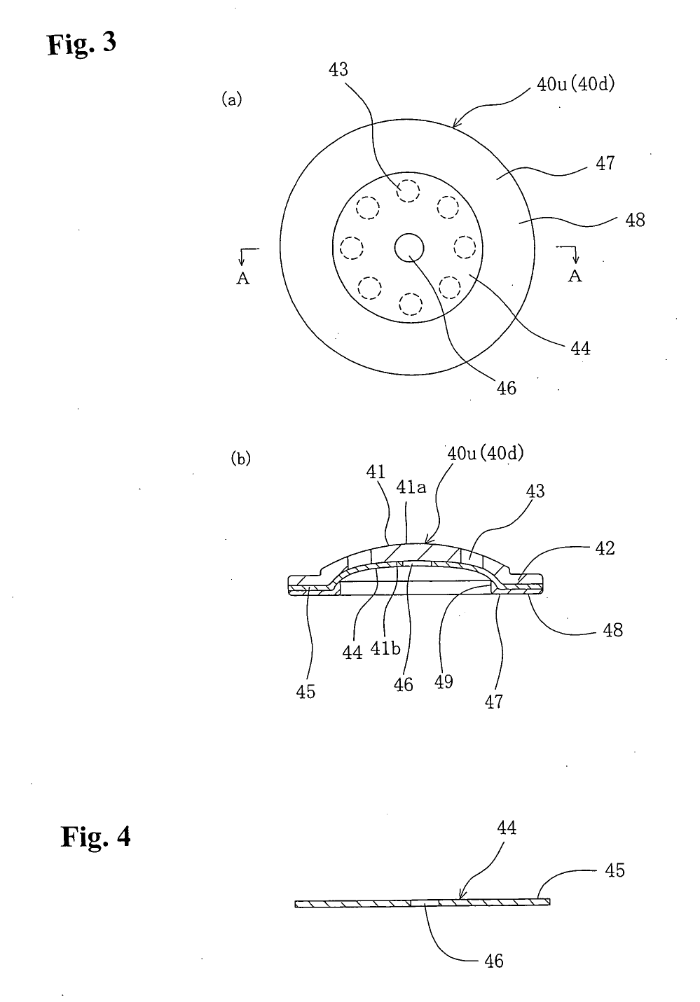

FIG. 3 shows a check valve used in the first embodiment of the present invention.

FIG. 4 is a cross sectional view of the valve body according to the first embodiment of the present invention.

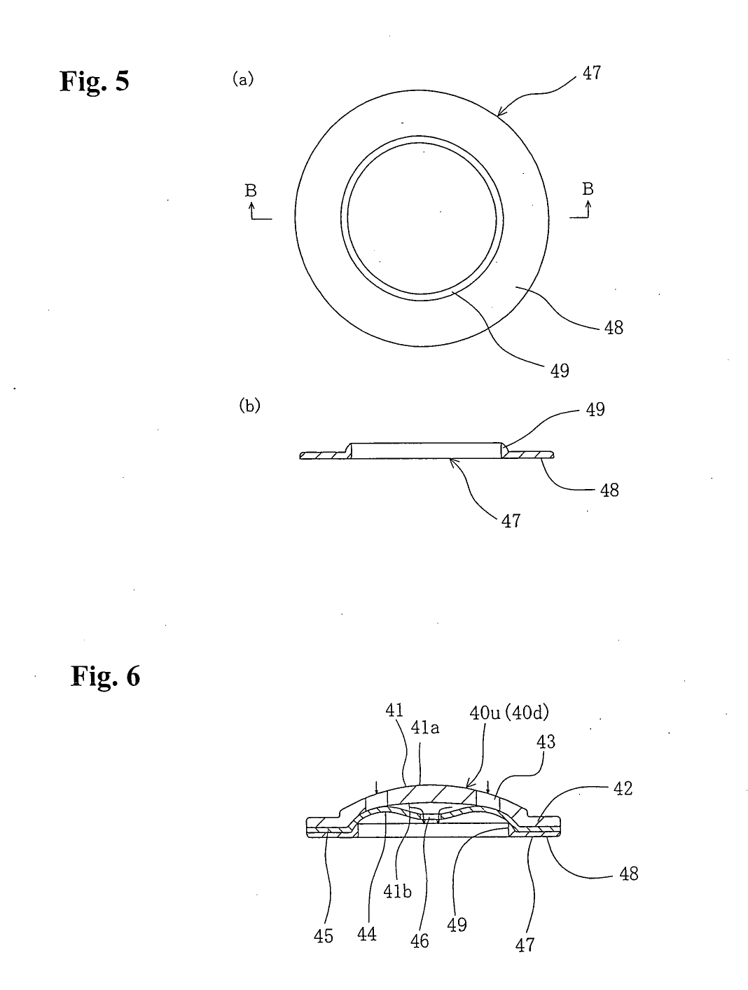

FIG. 5 shows a pressing element used in the first embodiment of the present invention.

FIG. 6 is a cross sectional view of the valve body of the check valve in an opened state according to the first embodiment of the present invention.

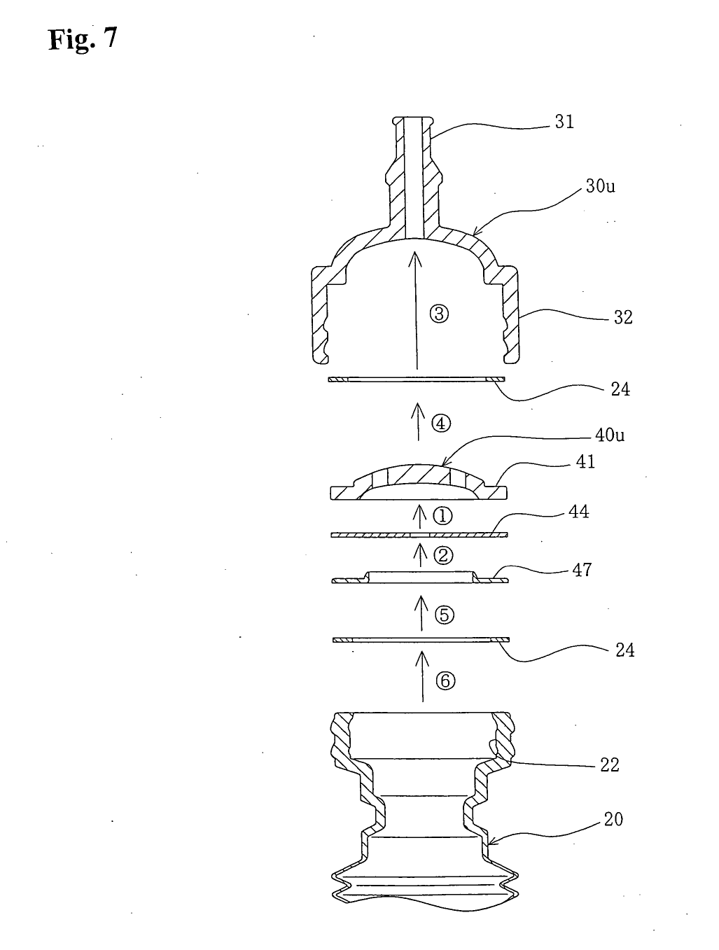

FIG. 7 shows the assembling process of the bellows pump in the first embodiment of the present invention. Additionally, in FIG. 3, (a) shows the check valve from the back, and (b) is a cross sectional view of A-A of (a). In FIG. 5, (a) shows a front view of the pressing element, and (b) is a cross sectional view of B-B of (a).

In a system for supplying a fixed amount of fluid according to the present embodiment, as shown in the FIG. 1, fluid supplying unit 1 has a bag 12 made of flexible film arranged within a box 11, and is comprised of fluid accommodating bag 2 encapsulating fluid therein and bellows pump 3 connected to the aforementioned fluid accommodating bag 2 via hose 13. In the present embodiment, the fluid subject to be supplied by the fluid supplying unit 1 would be viscous hot sauce of high temperature with granular substances such as spices included, or common coffee syrup of sort.

As shown in FIGS. 1 and 2, a bellows pump according to the present invention is comprised of bellows 20, nozzles 30u and 30d which is detachably mounted at the both ends of the aforementioned bellows 20 respectably and 2 check valves 40u and 40d which are placed respectably at the fluid-flow-inlet 23u of the upstream of the bellows and fluid-flow-outlet 23d of the downstream of the bellows. Further to this, in the present embodiment, packing 24, 24 are interposed at the upstream and the downstream of the check valves 40u and 40d in order to prevent the leakage of the fluid.

Furthermore, in the present embodiment, as shown in the FIG. 1, the fluid accommodating bag 2 and the upstream side of the bellows pump 3 is connected by hose 13, but it can also be designed so that the fluid accommodating bag 2 and the bellows pump 3 can be connected directly without the employment of the hose 13. Further to this, hose 14 is disposed at the downstream of the bellows pump 3, but it can be designed so that the fluid is directly delivered out from the bellows pump 3, or spraying device, atomizer and a fluid injection gun may be adopted in replacement according to the necessity in each case.

Aforementioned bellows 20 is a bellows member formed by blow-molding a soft synthetic resin such as polyethylene or polystyrene, and it is comprised of a accordion-shaped section 21 which can expand and contract freely in the vertical direction and end part of mounting element 22, 22 which are arranged at the both ends of aforementioned accordion-shaped section 21. On the end surfaces of the end part of mounting element 22, 22, fluid-flow-inlet 23u and fluid-flow-outlet 23d in the form of opening are arranged, and the check valves 40u and 40d are mounted thereon to allow the fluid inside the bellows 20 to be supplied or to be discharged. The internal volume of the bellows 20 is changeable by adjusting the longitudinal size thereof in the vertical direction. In addition, since the upper and the lower section of the bellows 20 is designed symmetric, whichever side can be arranged at the upstream or downstream.

Further to this, on the end part of the mounting element 22, 22, nozzles 30u and 30d is mounted so as to cover the aforementioned end part 22,22 respectively. In the present embodiment, since nozzle 30u and 30d are of identical shape, only the nozzle 30u will be described herein below. The nozzle 30u is made of resin materials such as plastic resin formed by injection molding, and provided with a nozzle opening 31 on the center of the end part of its outer surface, namely of the fluid-flow-inlet side, to be connected to hose 13, from thence allowing the fluid to flow in.

Furthermore, on its inner surface, namely on the side of the bellows 20, cylinder 32 is provided on the end portion of the mounting element 22, 22 in order to fix the nozzle 30u onto the bellows 20. This cylinder 32 also acts to retain the check valve 40u by pressing its periphery onto the fluid-flow-inlet 23u of the end part 22. The inner circumference of the cylinder 32 and the outer circumference of the end part of the mounting element 22 are designed in patterned indented surface so as to be fitted with one another, and thereby, nozzle 30u is detachably fixed on to the bellows 20.

In this embodiment, it is designed so that the nozzle 30u covers the outer surface of the end part 22 of the bellows 20, but end part 22 of the bellows 20 can be arranged to cover the outer surface of the nozzle 30u vice versa. In this case, however, the check valve 40u should be arranged within the end part 22.

Next, 2 check valves 40u and 40d arranged at the fluid-flow-inlet 23u and fluid-flow-outlet 23d of the aforementioned bellows 20 is described. In the present embodiment, the 2 check valves allow the movement of the fluid in only the direction from the fluid accommodating bag 2 (upstream) to the lower part (downstream). Herein below, the upper check valve 40u is described, as it is identical in the structure with the lower check valve 40d. The check valve 40u, as shown in FIG. 3, comprises a valve base 41, a valve body 44 formed of an elastic thin plate and covering the downstream surface 41b of the valve base 41 and a pressing element 47 arranged at the downstream surface of the valve body 44, which adds pressure so that the valve body 44 is compressed onto the downstream surface 41b of the valve base 41.

In the embodiment, valve base 41 is made of resin material such as plastic resin formed by injection molding, and as shown in FIG. 3, is of circular shape with its downstream surface 41b formed so that it is curved to be concave toward the upstream while its upstream surface 41a formed so that it is curved to be convex. Furthermore, a mounting flange 42 for mounting the valve body 44 is formed on its periphery. This mounting flange 42 has its upper surface formed in a flat plane at a single level lower with respect to the upstream surface 41a, so that the packing 24 of the upstream can be placed therein.

Also, the valve base 41 is provided with more than one fluid-flow-through holes 43, 43 penetrated from the upstream surface 41a to the downstream surface 41b. In the present embodiment, 8 fluid-flow-through holes 43, 43 are provided so as to be in parallel along the axis of the valve base 41 with each equally spaced there between in a concentric circle.

In the embodiment, the downstream surface 41b of the valve base 41 is formed to have a curved surface, but the shape is not limited to above in the present invention, and it can be composed in other shapes such as trapezoid shape. Also with regards to the upstream surface 41a, the shape is not limited merely to a curved surface, and it can be composed in other shapes such as flat surface. As for the fluid-flow-through holes 43, 43 provided on the valve base 41, their number and positioning are not particularly limited to above, and it can be adjusted freely.

As shown in FIGS. 3 and 4, the periphery 45 of the valve base 44 is retained in a clamping manner by the mounting flange 42 on its upstream and by the pressing element 47 on its downstream. In the embodiment, the valve body 44 is formed from an elastic material such as silicone rubber to have a circular plate shape which has a constant thickness of approximately 0.5 mm with a hole 46 formed at the center thereof, as shown in FIG. 4. This type of valve body 44 can be made simply by punching the elastic material in a form of planer to have a predetermined shape without employing other processing, and thus can be easily manufactured.

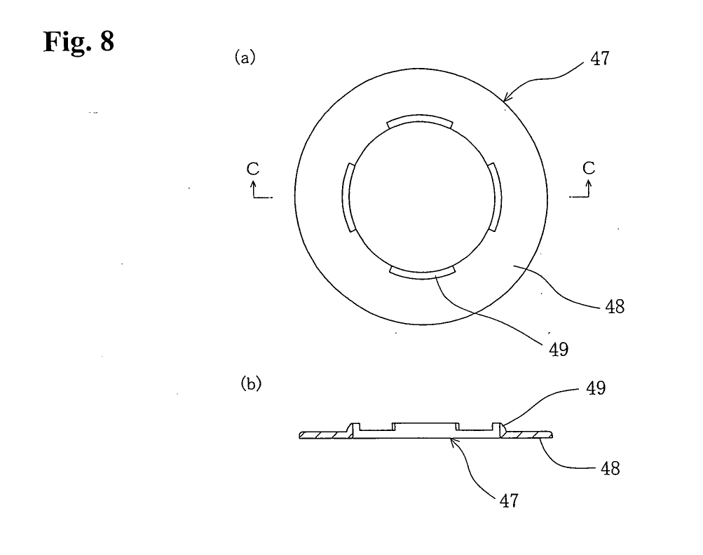

The pressing element 47 arranged at the downstream of the valve body 44 is provided for pressing the valve body 44 to adhere closely to the downstream surface 41b of the valve base 41. In the embodiment, this pressing element 47 is formed of resin material such as plastic resin by injection molding, and as shown in FIG. 5, it is comprised of circular ring shaped supporting part 48 which is retained by the periphery of fluid-flow-inlet 23u and pressing part 49 formed within the inner circumference of the supporting part 48, which adds pressure to the valve body 44 against the downstream surface 41b of the valve base 41. In the present embodiment, this pressing part 49 is composed as protrusions covering the entire inner circumference of the supporting part 48. However, the shape of this pressing part 49 may not be limited to what's described above, and can be formed in other shapes, as shown in FIG. 8, such as in a form to provide the pressing part 49 continuously on the inner circumference of the supporting part 48. Besides, on FIG. 8, (a) illustrates a front view of the pressing element 47, and (b) illustrates a cross-sectional view cut from c-c of (a).

With the pressing part 49 formed in a protruding figure, by pressuring the valve body 44 against the downstream surface 41b of the valve base 41 as shown in FIG. 3, it allows the valve body 44 to adhere closely against the downstream surface 41b of the valve base 41.

In its normal state, the check valve 40u of above described configuration makes the valve body 44 adhere closely to the downstream surface 41b of the valve base 41, so as to form the fluid-flow-through holes 43, 43 that encircles the hole 46 of the valve body 44 in a closed state. Further, when the pressure at the upstream side of this valve body 44 gets higher, it is elastically deformed to the downstream side as shown in FIG. 6 to form the fluid-flow-through hole 43, 43 in an opened state. Moreover, when the pressure at the upstream and the downstream side are approximately equal or when the pressure at the downstream side is higher, the valve body 44 adheres again onto the downstream surface 41b of the valve base 41, and makes the fluid-flow-through holes 43, 43 to become a closed state. Thereby, the secure opening and closing operations of the valve is realized.

In the check valve 40u and 40d of the present invention, the valve body 44 adheres closely to the downstream 41b of the valve base 41 with the pressing force exerted by the pressing element, and even when the valve body 44 thermally expands with the heat of the fluid of high temperature, the valve body 44 expands towards the upstream side in the present invention so as to adhere more closely to the downstream surface 41b of the valve base 41. Therefore, there will be no problem of having granular bits included in the fluid to get stuck between the valve base 41 and the valve body 44 when the thermal expansion of the valve body 44 occurs. Thereby, even when supplying the fluid such as hot sauce, the reverse flow of the fluid is securely prevented while precisely delivering a fixed amount of fluid.

The assembly of the bellows pump 3 is described herein below. First of all, the assembly at the upstream side is described. As shown in FIG. 7, the check valve 40u is assembled first in the assembling process of bellows pump 3. To be specific, the valve body 44 is placed on top of the valve base 41, and pressing element 47 is further pressed on top of it to assemble check valve 40u. To add few words, in the present embodiment, since the valve base 41, valve body 44 and the pressing element 47 do not possess features that engage with each other, the check valve 40u is in a state of trial fitting at this point.

Next, the packing 24 of the upstream side is placed inside the cylinder 32 of the nozzle 30u, and the trial fitted check valve 40u is further placed on top of it. Further to this, the packing 24 of the downstream is placed on top of the check valve 40u, and the end part of the mounting section 22 of the bellows 20 is pushed into the cylinder 32 of the nozzle 30u at last. Thereby the inner surface of the cylinder 32 and the outer surface of the end part of the mounting section 22 become fitted to each other, and the nozzle 30u is fixed onto the bellows 20. At this instance, the check valve 40u is pushed into the nozzle 30u side via the packing 24, 24 by the bellows 20, and maintained therein. Thereby the valve base 41, valve body 44 and the pressing element 47 are retained, clamped between bellows 20 and nozzle 30u by the periphery thereof. At this moment, the valve body 44 is adhered closely to the downstream surface 41b of the valve base 41 by means of pressing element 47.

Above passages described the assembly of the upstream side of the bellows pump 3. The downstream side is assembled likewise. The assembling processes presented above is describing only one of the examples, and the order of which individual parts are assembled is not limited to what mentioned above. For example, the packing 24 of the downstream, the pressing element 47, the valve body 44, the valve base 41 and the packing 24 of the upstream can be mounted at the end part of mounting section 22 of the bellows 20 in the above mentioned order, and the nozzle 30u can be mounted on top of it so as to cover them up.

Next, the supplying operation of the fluid in the present fluid supplying unit 1 is described. First of all, as preparation, the fluid supplying unit 1 is assembled in the present embodiment. As shown in FIG. 1, while the upstream of the bellows pump 3 and the fluid accommodating bag 2 are connected to each other with hose 13, hose 14 for discharging fluid is arranged in the downstream. Further to this, the upstream of the bellows pump 3 is fixed on to a fixture such as pole, and in the downstream of the bellows pump 3, an operational handle is arranged, which is to be used at the time of expanding and contracting the bellows 20 manually.

In order to discharge the fluid, the downstream of the bellows 20 is pulled downward manually to increase the inner volume of the bellows 20. Thereby, the pressure within the bellows 20 becomes lower, making the pressure to become higher in the upstream than in the downstream at the check valve 40u in the upstream, and the valve body 44 is pulled apart from the valve base 41 to open the fluid-flow-through holes 43, 43 of the valve base 41, enabling the fluid to flow through. Furthermore, in the check valve 40d at the downstream, the pressure in the downstream becomes higher than that in the upstream, and the valve body 44 is pushed towards the valve base 41, so as to maintain a closed state of the fluid-flow-through hole 43, 43 of the valve base 41, making it impossible for the fluid to flow through. Thereby, fluid is delivered into the bellows 20 from the fluid accommodating bag 2, and stored temporarily within the bellows 20.

As the fluid is stored inside the bellows 20 and the pressure within the bellows become higher, and when the pressure between the outside and the inside of the bellows 20 become equal, the valve body 44 of the check valve 40u adheres to the downstream surface 41b of the valve base 41 once again by the pressing force of the pressing element 47 at the upstream, which makes the fluid-flow-through holes 43, 43 in an closed state, so as to prevent the fluid to flow through. Thereby, the fluid supply from the fluid accommodating bag 2 is suspended in the check valve 40u at the upstream. Further, in the downstream, since the pressure difference produced between the upstream and the downstream is not as large as to elastically deform the valve body 44 of the check valve 40d, the valve body 44 is kept compressed onto the downstream surface 41b of the valve base 41, thereby maintaining the fluid-flow-through holes 43, 43 in a closed state.

In order to discharge the fluid, after expanding the bellows 20 and storing the fluid inside the bellows 20 as mentioned above, the inner volume of the bellows 20 is decreased by manually retracting the downstream of the bellows 20 upward. Thereby, the pressure within the bellows 20 is increased, and the pressure become higher in the downstream than in the upstream at the check valve of the upstream, and the valve 44 is pressed against the valve base 41 side, which results in forming the fluid-flow-through holes 43, 43 in a closed still state, preventing the fluid to flow. Furthermore, in the check valve 40d at the downstream, the pressure becomes higher in the upstream than that in the downstream, which allows the valve body 44 to be pulled apart from the valve base 41, forming an opened state in the fluid-flow-through holes 43, 43, and thus allowing the fluid to flow through. Thereby, the fluid accommodated within the bellows 20 is discharged from the check valve 40d in the downstream.

After the fluid within the bellows 20 is discharged and the pressure therein becomes lower, and when there exist no pressure difference with the outside of the bellows 20, since the pressure difference between the upstream and the downstream is not as large as to elastically deform the valve body 44 of the check valve 40u at this point, the valve body 44 is kept compressed against the downstream surface 41b of the valve base 41. Further in the downstream, the valve body 44 of the check valve 40d is once again adhered closely against the downstream surface 41b of the valve base 41 by the pressing force of the pressing element 47, forming a closed state in the fluid-flow-through holes 43, 43, so as to prevent the fluid to flow through. Thereby, the discharge of the fluid inside the bellows 20 is suspended.

Considering the aforementioned expand-contract movement as one stroke, it becomes possible to supply a fixed amount of fluid with this one stroke. Besides, in the present embodiment, it is described to expand and contract the bellows 20 manually, but it can be designed so that the bellows 20 will automatically expand and contract by employing pump driving mechanism. Moreover, in the embodiment, to fix the upstream of the bellows 20 and to perform expand and contract movement is done by moving the downstream side vertically is introduced, but it can also be designed to have the downstream side fixed and to move the upstream side vertically, or to expand and contract by moving the both ends with neither side fixed. Furthermore, in the present embodiment, it is arranged so that the upstream of the bellows pump 3 is at higher side and the downstream side is at lower side as shown in FIG. 1, but since the bellows pump 3 has a mechanism to distribute the fluid by means of the pressure difference, it can also be employed with the upstream side arranged at the lower end and downstream surface at the higher end.

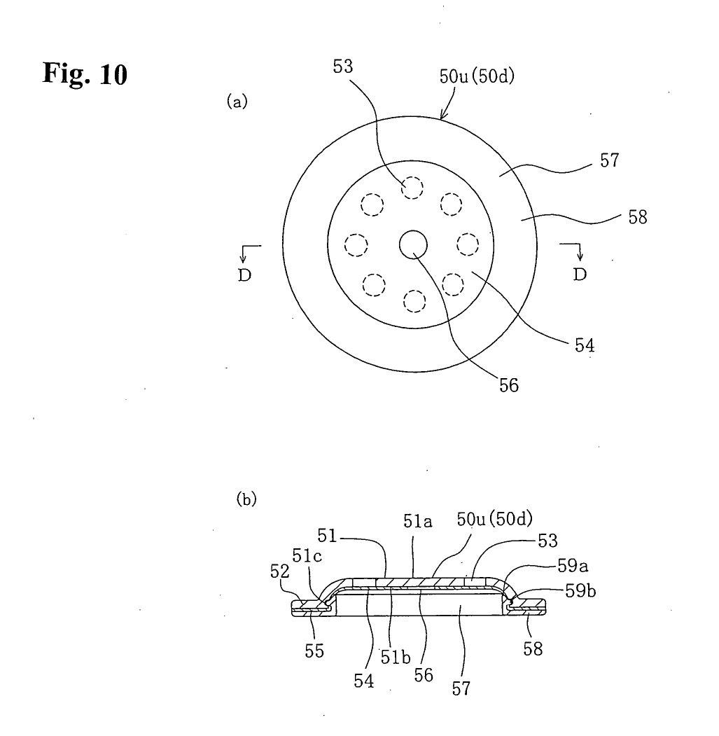

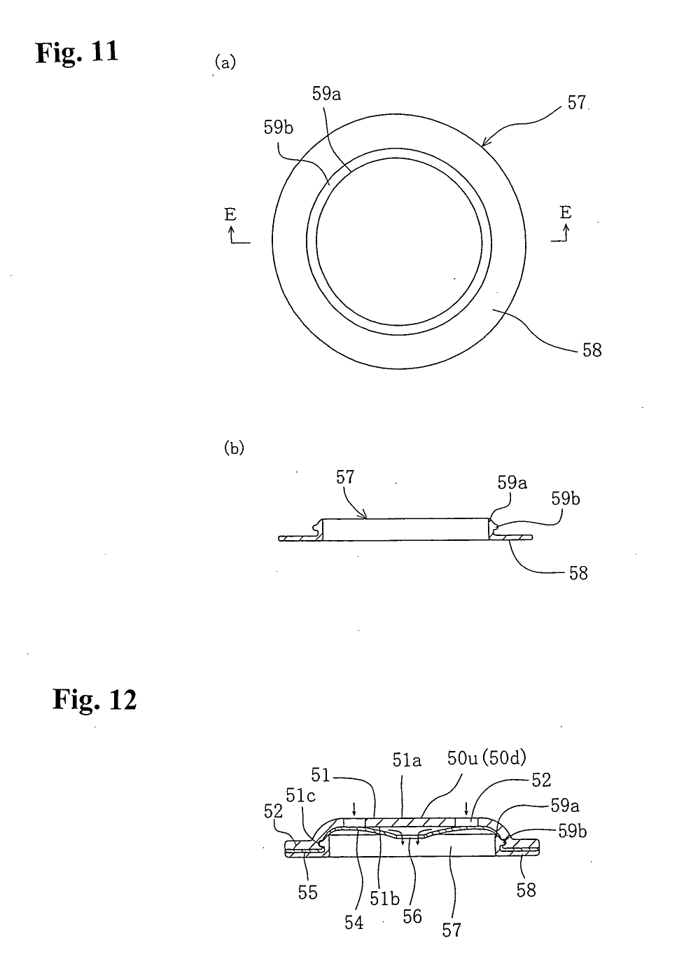

The description of the first embodiment of the present invention was described herein above, but the check valve according to the present invention is not limited to the composition mentioned above, and it is also possible to adopt other compositions. The second embodiment of the check valve is explained herein below. FIG. 11 illustrates the pressing element in the second embodiment and FIG. 12 is a cross-sectional view of the check valve of the second embodiment with its valve body in an opened state. In addition, in FIG. 10, (a) is a back view and (b) is a cross-sectional view of D-D of (a). Furthermore, in FIG. 11, (a) is a front view of the pressing element and (b) is a cross-sectional view of E-E of (a).

Likewise in the first embodiment, in the present embodiment, since the check valve 50u at the upstream and the check valve 50d at the downstream are formed in an identical structure, only the check valve 50u at the upstream is described herein below. As shown in FIG. 10, the check valve 50u according to the present embodiment is comprised of a valve base 51, a valve body 54 which adheres closely to the downstream surface 51b of the aforementioned valve base 51 and a pressing element 57 which is arranged at the downstream side of the aforementioned valve body 54 and add pressure onto the valve body 54.

In the embodiment, the valve base 51 is formed in a circular shape as shown in FIG. 10, and the upstream surface 51a is formed in generally trapezoid shape curved to be convex while its downstream surface 51b is formed in generally trapezoid shape curved to be concave towards the upstream. Further to this, a mounting flange 52 for mounting the valve body 54 is formed on its periphery. This mounting flange 52 has its upper surface formed in a flat plane at a single level lower with respect to the upstream surface 51a, so that the packing 24 of the upstream can be placed therein.

On this valve base 51, 8 fluid-flow-through holes 53, 53 . . . are provided in circular shape with each equally spaced there between.

The valve body 54 is made from an elastic material to have a circular disc shape with a hole 56 formed at the center, and as shown in FIG. 10, the periphery 55 of the valve base 54 is retained by the mounting flange 52 on its upstream and by the pressing element 57 on its downstream in a clamping manner.

Here, as shown in FIG. 11, the pressing element 57 in the present embodiment has supporting part 58 which is formed in a ring shape and retained by the periphery of fluid-flow-inlet 23u, and the pressing part 59a which is formed on the inner surface of the aforementioned supporting part 58 allowing the valve body 54 to be adhered against the downstream 51b of the valve base 51 produced thereon. The valve body 54 is pressed against the downstream 51a of the valve base 51 so that it will adhere closely thereon.

In addition, mounting part 59b of protruding shape is formed on the entire outer surface of the pressing part 59a. In accordance with this, fitting part 51c in a form of groove is designed on the downstream surface 51b of the valve base 51 to properly fit with the protruding mounting part 59b as shown in FIG. 10. By engaging the mounting part 59b and the fitting part 51c with the valve body 54 placed in between the mounting part 59b and the fitting part 51c, it is possible to retain the valve body 54 against the downstream surface 51b of the valve base 51 more firmly. Thus, with this composition, trial fitting of the check valve 50u becomes possible, which results in the enhancement of operation.

In the check valve 50u of the aforementioned composition, the opening and shutting of the fluid-flow-through holes 53, 53 . . . of the valve base 51 is realized by compressing and detaching the section located more inside than the spot pressed by the mounting part 59b of the valve body 54 from the downstream surface 51b of the valve base 51 as shown in FIGS. 10 and 12. In the present embodiment, the fitting part 51c of the valve base 51 is composed as a groove, and composed to have the mounting part 59b of the pressing element 57 fitted thereon, but it can also be composed transversely so as to form the groove on the mounting part 59b of the pressing element 57, and fitted with the concavely shaped fitting part 51c formed at the downstream surface of the valve base 51.

Furthermore, in the present embodiment, it is composed to have the periphery 55 of the valve body clamped by the mounting flange 52 of the valve base 51 and the supporting part 58 of the pressing element 57 in order to have it retained, but it can also be designed to compose the pressing element 57 without the supporting part 58, and let the valve body 54 retained at the downstream surface 51b of the valve base 51 only by the clamping of the mounting part 59b and fitting part 51c.

Above is the description on the embodiment of the present invention. In each of the aforementioned embodiment, explanation is made on the basis of using hot sauce as an example of the type of fluid to be delivered by a fixed amount. The bellows pump according to the present invention is purposed to deliver a fixed amount of such viscous fluid of hot temperature containing tiny granular bits, and also to properly function the check valve, but the type of fluid which is object of the bellows pump according to the present invention is not only limited to the viscous fluid of hot temperature such as hot sauce. Which means bellows pump according to the present invention is able to supply any kind of fluid regardless of their temperature and viscosity such as water, warm water, soft drinks to be supplied without dilution such as juice, alcoholic liquors, seasonings to be supplied by a fixed amount such as ketchup, mayonnaise, mustard, sauce, and seasonings supplied to soup for noodles may be applied to the present invention.

Thus, when a system for supplying a fixed amount of fluid according to the invention is used for food in such a manner, the food contamination due to the reverse flow of the food can be prevented while enabling the precise and secure supply of a fixed amount of food.

The fluid applied to the present invention is not limited to food; other kinds of fluid such as irrigation water for vegetation, liquid fertilizer, agricultural chemicals, oils such as lubricating oil and grease, adhesive and glue may be used. Because of the disposability of the pump and the fluid container, they do not require cleansing and washing, which is favorable from a hygienic point of view, especially when it is used for oil and adhesive that takes up time in cleansing.

Alternatively, it can also be used as a system to supply a fixed amount of fluid for supplying a fixed amount of liquid soap for washing hands, which is installed at the washing rooms of places such as business establishments, department stores and parks. In the same scope as mentioned above, due to the disposability of the pump and the fluid container, they do not require cleansing and washing, which is favorable from a hygienic point of view.

Thus, the field in which the system for supplying a fixed amount of fluid according to the present invention is applied can be any field as long as it concerns with supplying a fixed amount of fluid. To raise few examples 1) to provide post-mix beverages, pre-mix beverages, tea, hot water and such, as a means for providing drinks out of a store, 2) to provide post-mix beverages, pre-mix beverages, to pour in seasonings such as ketchup, mayonnaise, sauce, and to pour soup, sauce and such for noodles, as a means for providing a fixed amount of drinks, alcohols and seasoning fluid at stores 3) pouring in seasonings to food products and pouring in soup and sauce for noodles in food manufacturing, as a means for providing a fixed amount of seasoning and seasoning liquors in the field of the food industry.

Furthermore, the present invention can be employed as bellows pump to supply a fixed amount of fluid in various fields, such as for use in gardening, agricultural field, industrial field and also for use in domestic.

### EFFECT OF THE INVENTION

According to the invention described hereinabove, the check valve is comprised of a valve base with its downstream surface formed in a concaved shape while provided with more than one fluid-flow-through holes piercing through it, a valve body, formed of elastic material in thin plate while having hole at the center for allowing fluid to flow, which is disposed at the downstream surface of the valve base and a pressing element which adds pressing force to the valve body so that it will adhere closely to the downstream surface of the valve base. Since the valve body adheres to the downstream surface of the valve base by the pressing force of the pressing element, the check valve adheres closely to the downstream surface of the valve base with the pressing force of the pressing element in the primary state, and supposing that the valve body thermal expands due to the heat of the fluid of hot temperature, valve body expands towards the upstream surface so as to make the valve body adhere more closely to the downstream surface of the valve base. Accordingly, gap will not be formed in between the valve base and the valve body, which means that no granular bits will get stuck between the valve base and the valve body. From this point, it is possible to pump out a fixed amount of fluid without fail, and also assures to avoid the reverse flow of the fluid even for the viscous fluid of hot temperature including granular bits. Furthermore, it can be adequately used also for supplying warm or cold syrup and such.

Further, according to the present invention, since the pressing element is comprised of a supporting part, which is retained at the periphery of the fluid-flow-inlet or fluid-flow-outlet formed at the both ends of the bellows, and a pressing part, which is formed at the inner circumference of the supporting part to press the valve body against the valve base, it is possible to accurately adhere the valve body against the downstream surface of the valve base, and to perform the opening and closing of the valve without fail. In particular, with the supporting part designed in a ring shape with the pressing part developed in a protruding shape on its entire inner circumference, it becomes possible to press the valve body towards the valve base over the entire circumference.

Furthermore, according to the present invention, the assembled state of the check valve can be maintained for certain by having the valve base, valve body and the pressing element retained clamped with the bellows and the nozzle on each of their periphery.

Furthermore, according to the present invention, connecting and detaching of the nozzle onto the bellows can be performed with more ease by having each of the nozzles mounted at both ends of the bellows provided with cylinder at the side connected to the bellows, and having the nozzle retained to the bellows by making the cylinder adhere to the end part of the bellows.

Additionally, according to the present invention, a fixed amount of fluid can quickly be pumped out from the hole of the valve body by having the valve body formed in a circular thin plate from a thin elastic film such as silicone rubber while having the circular hole produced at the center thereof, and producing more than one fluid-flow-through holes on the valve base in parallel to the axis of the valve base while arranging those holes equally spaced around the hole produce at the center of the valve body.

The afore-described valve body can be manufactured easily by just punching the flat plate in the prescribed shape in perforation molding, without employing other processes.

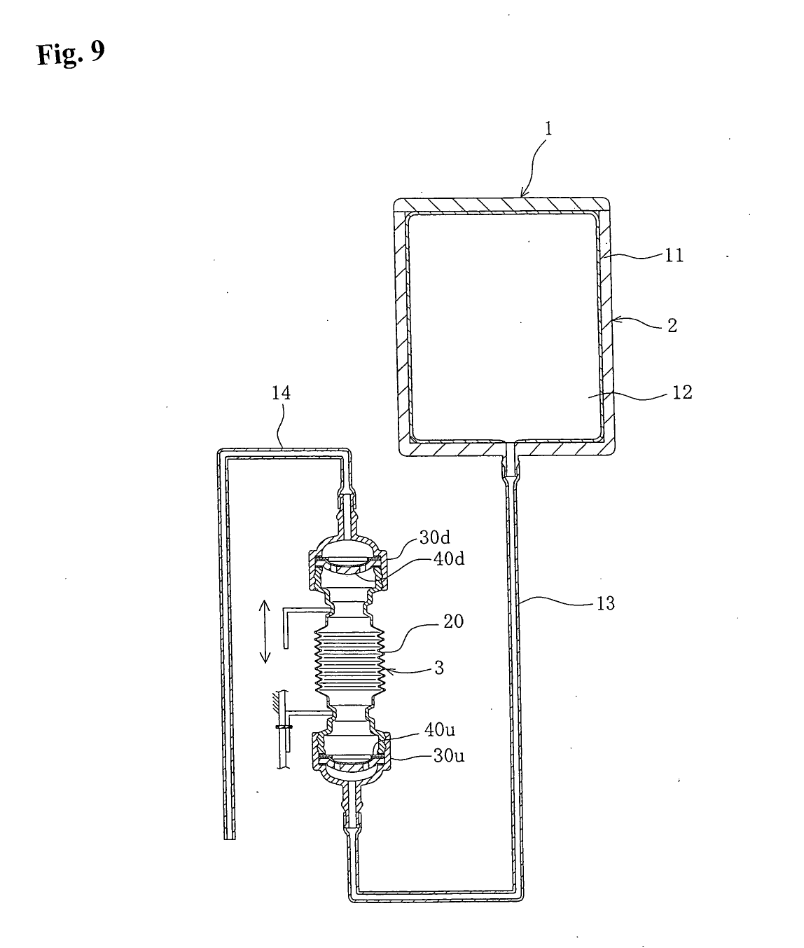

### BRIEF DESCRIPTION OF THE DRAWINGS

[FIG. 1] A cross-sectional drawing showing the system to supply a fixed amount of fluid in the first embodiment according to the present invention.

[FIG. 2] A cross-sectional drawing of the bellows pump in the first embodiment according to the present invention.

[FIG. 3] A drawing which illustrates the check valve in the first embodiment according to the present invention.

[FIG. 4] A cross-sectional drawing of the valve body in the first embodiment according to the present invention.

[FIG. 5] A drawing which illustrates the pressing element in the first embodiment according to the present invention.

[FIG. 6] A cross-sectional drawing showing the valve body of the check valve in an opened state in the first embodiment according to the present invention.

[FIG. 7] A drawing which illustrates the assembling processes of the bellows pump in the first embodiment according to the present invention.

[FIG. 8] A drawing which illustrates the pressing element in other forms of embodiment.

[FIG. 9] A cross-sectional view showing the system for supplying a fixed amount of fluid in other forms of embodiment.

[FIG. 10] A drawing which illustrates the check valve in the second embodiment according to the present invention.

[FIG. 11] A drawing which illustrates the pressing element in the second embodiment according to the present invention.

[FIG. 12] A cross-sectional drawing showing the valve body of the check valve in an opened state in the second embodiment according to the present invention.

1. A bellows pump comprising a bellows formed in a shape of accordion, nozzles mounted detachably on both ends of the aforementioned bellows and 2 check valves, which are placed at the fluid-flow-inlet and fluid-flow-outlet provided at both ends of the aforementioned bellows;
wherein each of the aforementioned check valve is comprised of a valve base with its downstream surface concaved with more than one hole pierced through it, a valve body made of elastic thin plate which is fixed to the downstream surface of the aforementioned valve base with a hole formed at its center for allowing the flow of the fluid, and a pressing element which adds pressure to the aforementioned valve body allowing it to be compressed against the downstream surface of the aforementioned valve base,
wherein aforementioned valve body is compressed against the downstream surface of the aforementioned valve base by the pressing force of the aforementioned pressing element, while freely compressing one of the valve body against the valve base and pulling apart the other valve body from the valve base by the expanding and contracting movement of the aforementioned bellows.

2. A bellows pump according to claim 1, wherein each of the aforementioned check valve is retained by the end part of the aforementioned bellows on its periphery, and the check valve at the upstream side is disposed so that the concaved surface is facing the bellows, while the check valve at the downstream side is disposed so that the concaved surface is facing the nozzle at the outlet end.

3. A bellows pump according to claim 1, wherein the aforementioned pressing element is comprised of supporting part, which is retained on the periphery of the fluid-flow-inlet or fluid-flow-outlet formed at the both ends of the aforementioned bellows, and a pressing element which is formed in the inner perimeter of the aforementioned supporting part and designed to compress the aforementioned valve body against the downstream surface of the aforementioned valve base.

4. A bellows pump according to claim 3, wherein the aforementioned pressing element is formed so that the supporting part is in a shape of circular ring, while the pressing part is formed on the entire circumference of the inner perimeter of the supporting part in a protruding shape.

5. A bellows pump according to claim 1, wherein valve bases and valve bodies which comprise the aforementioned check valves, as well as the pressing element that compresses the valve body against the valve base, are retained with the aforementioned bellows and nozzle clamping the periphery of each of the elements.

6. A bellows pump according to claim 1, wherein the nozzles mounted at both ends of the aforementioned bellows are both provided with cylinders, and both nozzles are fixed to the aforementioned bellows by fastening the cylinders onto the ends of the aforementioned bellows.

7. A bellows pump according to claim 1, wherein the aforementioned valve body is made of elastic material such as silicone rubber in a form of circular plate by thin film having a round hole at the center thereof, while more than one fluid-flow-through holes on the aforementioned valve base are arranged in parallel with the axis of the valve base, and spaced equally on the concentric circle, which is situated on the aforementioned axis.

8. A bellows pump according to claim 1 characterized in emitting a fixed amount of fluid into the bellows through the check valve arranged at the upstream surface with the expanding movement which compresses the valve body of the check valve arranged at the downstream surface against the valve base and pulls apart the valve body of the check valve arranged at the upstream surface from the valve base at the same time, and also emitting a fixed amount of fluid accommodated in the bellows through the check valve arranged at the downstream surface of the check valve with the contracting movement which compresses the valve body of the check valve arranged at the upstream surface against the valve base, and pulls apart the valve body of the check valve arranged at the downstream surface from the valve base at the same time, with the expansion and contraction of the aforementioned bellows.

9. A system for supplying a fixed amount of fluid comprising a fluid accommodating bag for accommodating fluid therein and a bellows pump connected to the aforementioned fluid accommodating bag, which supplies a fixed amount of fluid by generating this bellows pump;
wherein aforementioned bellows pump comprises a bellows in a form of accordion, nozzles disposed detachably at the both ends of the aforementioned bellows, and 2 check valves arranged at the fluid-flow-inlet and fluid-flow-outlet of both ends of the aforementioned bellows respectively,
wherein each of the aforementioned check valves comprises a valve base with its downstream surface concaved with more than one fluid-flow-through holes piercing through it, a valve body arranged at the downstream surface of the aforementioned valve base, which is made of elastic thin plate with a hole at the center thereof to allow fluid to flow, and a pressing element which adds pressure so that the aforementioned valve body adheres closely to the downstream surface of the aforementioned valve base,
wherein aforementioned valve body is compressed onto the downstream surface of the aforementioned valve base by the pressing force exerted by the aforementioned pressing element, and by expanding and contracting one or both ends of the aforementioned bellows, valve body of the check valve arranged at the downstream surface is compressed against the valve base with the expanding movement, while valve body of the check valve arranged at the upstream surface is pulled apart from the valve base with the contracting movement, and a fixed amount of fluid is thereby delivered to the bellows from fluid accommodating bag via the check valve arranged at the upstream surface,
which is characterized by delivering a fixed amount of fluid in the bellows via the check valve arranged at the downstream by compressing the valve body of the check valve arranged at the upstream against the valve base, while pulling apart the valve body of the check valve arranged at the downstream from the valve base at the same time with the contracting movement.
